(19) United States
(12) Patent Application Publication
(10) Pub. No.: US 2007/0009136 A1
(43) Pub. Date: Jan. 11, 2007

(54) Digital imaging for vehicular and other security applications

(76) Inventors: Ivan Pawlenko, Holland, PA (US); Larry Samson, Langhorne, PA (US)

Correspondence Address: Lucent Technologies Inc.;Docket Administrator - Room 3J-219, 101 Crawfords Corner Road, Holmdel, NJ, 07733-3030, US

(21) Appl. No.: 11/172,003

(22) Filed: Jun. 30, 2005

(51) Int. Cl. G06K 9/00

(52) U.S. Cl. 382/104

(57) ABSTRACT

Apparatus for inspecting a vehicle in order to determine whether portions of the vehicle have been altered to conceal contraband or explosives. The apparatus captures an image of an area of a vehicle that should not be altered from a known configuration and compares the image to a reference image of the area as it should appear if it is unaltered. If the captured image and the reference image match, the vehicle is considered unaltered, and hence safe to pass. If the captured image and the reference image do not match, the vehicle is identified as likely to have been altered, and hence a candidate for further inspection. An alert is produced if at least one such difference is found.

### TECHNICAL FIELD

This invention relates to the use of digital imaging for security applications.

### BACKGROUND OF THE INVENTION

Security checks, such as those performed at border crossings and entry points to high-risk areas, e.g., bridges, tunnels, government owned buildings, airports, harbors, etc., often involve stopping a vehicle, e.g., an automobile, airplane, train, or boat, and inspecting it to determine whether it contains contraband or explosives. For areas of the vehicle not easily visible by the inspector, e.g., the underside of a vehicle, use may be made of a mirror attached to an extended rigid handle, e.g., a long rod or a staff, to enable the inspector to inspect such areas.

Unfortunately, such a mirror only provides a limited view of the total underside of the vehicle. Also disadvantageously, the inspector has no way to compare what is being seen to what is appropriate to be present for the particular vehicle being inspected. Further disadvantageously, the inspectors view may be limited by the illumination that is available underneath the vehicle.

### SUMMARY OF THE INVENTION

We have recognized that the problems of the prior art of vehicle inspection may be avoided by automatically a) inspecting areas of a vehicle that should not be altered and b) determining whether such areas have been altered. This may be achieved, in accordance with an aspect of the invention, by an apparatus that i) captures an image of an area of a vehicle that should not be altered from a known configuration and ii) compares the image to a reference image of the area as it should appear if it is unaltered. If the captured image and the reference image match, the vehicle is considered unaltered, and hence safe to pass. If the captured image and the reference image do not match, the vehicle is identified as likely to have been altered, and hence a candidate for further inspection.

In one embodiment of the invention, an automatic vehicle inspection system captures an image of the underside of a vehicle at a checkpoint. The image may be captured using, for example, a scanner built into, or placed on, the floor over which the vehicle is driven. An identifier of the vehicle, e.g., the vehicle's license plate number and/or the vehicle identification number (VIN), is obtained and used to obtain a stored copy of a reference image of the underside of the vehicle from a database. The database may be located local to, or remote from, the vehicle inspection system.

The vehicle inspection system performs an image matching process to compare the captured image of the vehicle's underside to the reference image to determine whether the images match. If the captured image and the reference image match, the vehicle is considered unaltered, and hence safe to pass through the checkpoint. If the captured image and the reference image do not match, the vehicle is identified as likely to have been altered, and hence not safe to pass, but instead to be a candidate for further inspection. In the latter case, areas of difference between the captured image of the vehicle's underside and the reference image may be identified, e.g., highlighted, and an alert is produced so that an inspector may investigate such differences.

Advantageously, when using the automatic vehicle inspection system an inspection may be made of the total underside of a vehicle, rather than merely a portion thereof, as was done in the prior art. Furthermore, the same approach can be used for other areas of a vehicle that should remain unaltered after a reference image is taken, e.g., the engine compartment.

The image capture portion of the automatic vehicle inspection system typically can capture an adequate image with less light than is required by a human being to make a comparable inspection. Also, the automatic vehicle inspection system may be able to operate with wavelengths of light that are not visible to human beings. Thus, the automatic vehicle inspection system does not need an environment that has adequate lighting for visual perception by a human being. Further advantageously, the automatic vehicle inspection system does not depend upon a human operator to determine whether areas of the vehicle that should not be altered have been altered, and so it is less prone to errors than a human-based inspection system.

### BRIEF DESCRIPTION OF THE DRAWINGS

FIG. 1 shows an exemplary automatic vehicle inspection system arranged in accordance with the principles of the invention; and

FIG. 2 shows a flow chart for a method of operating an automatic vehicle inspection system arranged in accordance with the principles of the invention.

### DETAILED DESCRIPTION

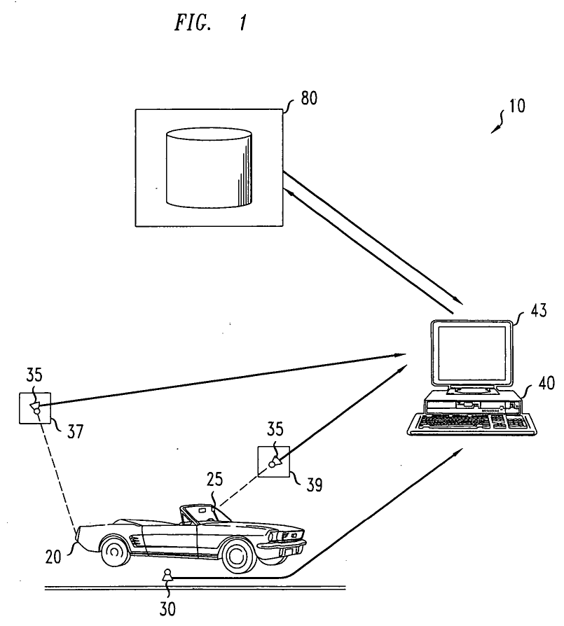

FIG. 1 shows an exemplary automatic vehicle inspection system 10 arranged in accordance with the principles of the invention. Shown in FIG. 1 are image capture system 30, vehicle identification device 35, processor 40, monitor 43, and database 80. Also, shown in FIG. 1 is vehicle 20, a vehicle to be inspected at a checkpoint at which automatic vehicle inspection system 10 is implemented.

Image capture system 30 captures at least one image of at least one area of a vehicle that should remain unaltered, e.g., the underside of a vehicle. To that end, image capture system 30 is positioned so that it can capture an image of the area of interest of vehicle 20. In the embodiment of the invention shown in FIG. 1, image capture system 30 is located in the floor over which vehicle 20 is driven, thereby positioning it to capture an image of the underside of vehicle 20. Image capture system 30 may capture an image of vehicle 20 when it is stopped at the checkpoint, or while vehicle 20 is moving through the checkpoint.

Image capture system 30 may be a digital camera, scanner, machine vision system, or the like. Image capture system 30 may be such that it can capture an image with less light than is required by a human being to make an inspection. Alternatively, image capture system 30 may be able to operate with wavelengths of light that are not visible to human beings.

Image capture system 30 may have a built-in controller or processor 40 may control it. The output of image capture system 30 is supplied to processor 40.

Vehicle identification device 35 is a device capable of obtaining information that identifies the vehicle being inspected. The vehicle identifying information may be obtained, for example, a) from character information written on the vehicle; b) from coded information printed on the vehicle, e.g., bar code or other pattern information; c) from a radio frequency identification (RFID) type tag in the vehicle; d) from a port on the vehicle, such as may be connected to the vehicle's computer; or e) from the shape and details of the exterior of the vehicle. FIG. 1 shows two different possible locations, location 37 and location 39, for vehicle identification device 35. The particular location actually employed depends upon the particular implementation as described hereinbelow.

As noted, in one embodiment of the invention shown in FIG. 1, vehicle identification device 35 may obtain the vehicle identifying information from characters affixed to vehicle 20. For example, vehicle identification device 35 may capture an image of at least one area of vehicle 20 that is expected to contain characters, such as the license plate area or an area known to contain the manufacturer's specified vehicle identification number (VIN), i.e., a unique serial number, of vehicle 20. To this end, vehicle identification device 35 may be located at location 37, so that a digital image of the rear license plate area of vehicle 20 is obtained, since not all government licensing entities require a vehicle to have a license plate in front. Alternatively, vehicle identification device 35 may be located at location 39, so that an image of an area on the inside of the windshield where the VIN is conventionally located, e.g., printed on a tag, may be obtained.

Similar to image capture system 30, vehicle identification device 35 may be a digital camera, scanner, machine vision system, or the like. Also, similar to image capture system 30, vehicle identification device 35 may be able to capture an image with less light than is required by a human being to perform an adequate inspection, or it may be able to operate with wavelengths of light that are not visible to a human being.

An image captured by vehicle identification device 35 may be analyzed using well-known character recognition techniques to determine the characters contained in the area. The image area may be analyzed by vehicle identification device 35 itself, or in conjunction with, or wholly by processor 40. The resulting character string is stored by processor 40.

In another embodiment of the invention, vehicle identification device 35 is a bar code scanner that scans a bar code pattern printed on the vehicle. The scanned pattern is then converted to a corresponding digital representation, e.g., the characters corresponding to the bar code.

In a further embodiment of the invention, vehicle identification device 35 is a RFID tag reader, which obtains an identifying code by use of an antenna that uses radio frequency waves. More specifically, vehicle identification device 35 may transmit a radio signal that activates transponder/tag 25 located in vehicle 20. When activated, transponder/tag 25 transmits back to the antenna of vehicle identification device 35 data which includes the identifying code. In such an embodiment of the invention, vehicle identification device 35 may be located at location 35.

In yet another embodiment of the invention, vehicle identification device 35 is capable of obtaining an image of a portion of a vehicle, e.g., part of the exterior of vehicle 20. Using image matching techniques the image area may be analyzed by vehicle identification device 35 itself, or in conjunction with, or wholly by processor 40, to determine the year, make, and model of vehicle 20 from the captured image.

Note that although two possible locations for vehicle identification device 35 have been shown, other locations are possible as well. Based on the foregoing, those of ordinary skill in the art will readily be able to place vehicle identification device 35 at an appropriate location to best capture the information of the type to be obtained by any particular embodiment of vehicle identification device 35.

Processor 40 may be any type of processor. Processor 40 can perform image matching techniques so as to determine whether areas of a captured image and a reference image match. Processor 40 should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. The functions of processor 40 may be provided by a single dedicated processor, by a single shared processor, or by a plurality of individual processors, some of which may be shared.

In one embodiment of the invention, processor 40 may be a conventional computer that has software to perform image matching available to it. The image matching may be flexible enough to ignore minor differences between the captured image and the reference image, such as vendor names on replacement parts installed after delivery of a vehicle to its owner, and to yet consider such images to match. Also, processor 40 may be able to display, e.g., on monitor 43, the differences identified by the image matching.

Database 80 stores reference images of vehicles as they should appear if the vehicle is unaltered. The reference images are organized so that when information identifying a particular vehicle, or type of vehicle, is presented, the corresponding reference image may be retrieved. Thus, for example, database 80 may store a reference image of the underside of vehicle 20, and this stored reference image will be retrieved in response to presentation of an identifier of vehicle 20. The identifier may be any identifying information capturable by vehicle identification device 35. Database 80 may be stored local to processor 40, or remote therefrom.

The reference images used to populate database 80 may be supplied by a) a vehicle manufacturer, which could supply such an image immediately after manufacturing the vehicle; or b) a vehicle dealer, e.g., which could supply such an image before delivery of the vehicle to its buyer, so that the image may be taken after post manufacture vehicle customization. Also, special scanning stations may be provided by, for example, the government or security organizations, to capture, and supply for storage in database 80, images of vehicles already in use by their owners.

Those of ordinary skill in the art will readily be able to select processors, databases, vehicle identification devices and image capture systems appropriate for use in any particular implementation of an automatic vehicle inspection system.

Advantageously, when using the automatic vehicle inspection system 10 an inspection may be made of the total underside of vehicle 20, rather than merely a portion thereof, as was done in the prior art. Furthermore, the same approach can be used for other areas of a vehicle that should remain unaltered after a reference image is taken, e.g., the engine compartment. Also, advantageously, vehicle inspection system 10 can operate under lighting conditions not amenable to human inspections. Further advantageously, automatic vehicle inspection system 10 does not depend upon a human operator to determine whether areas of vehicle 20 that should not be altered have been altered, and so it is less prone to errors than a human-based inspection system.

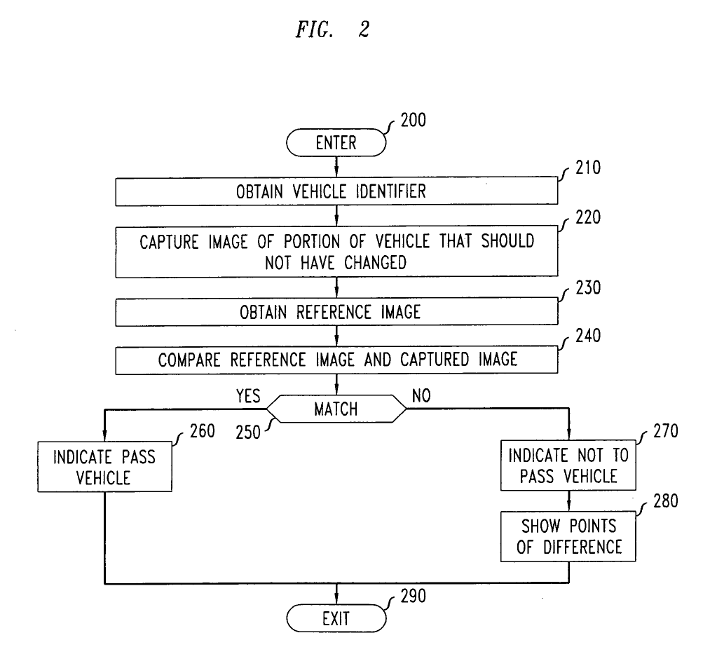

FIG. 2 shows a flow chart of a process for performing a vehicle inspection in accordance with the principles of the present invention. The process is entered in step 200 when a vehicle approaches a checkpoint equipped with an automatic vehicle inspection system, such as is shown in FIG. 1.

In step 210 (FIG. 2), a vehicle identifier, e.g., i) a license plate number; ii) a VIN; iii) a RFID tag number; iv) a bar code; v) the year, make and model type of a vehicle; or other information identifying the vehicle, is obtained. This step may be performed when the vehicle is positioned within range of vehicle identification device 35 (FIG. 1), and possibly in conjunction with processor 40.

In step 220 (FIG. 2), an image of an area of the vehicle that should not have been altered since a reference image of that area was stored, e.g., the underside or engine compartment, is taken when the vehicle is positioned to facilitate the taking of such an image, e.g., by image capture system 30 (FIG. 1). Next, in step 230 (FIG. 2), a reference image of the area of the vehicle captured in step 220 is obtained. The reference image is obtained as a function of the vehicle identifier obtained in step 210. The reference image may be obtained from database 80 (FIG. 1).

In step 240 (FIG. 2), the captured image of the vehicle is compared with the reference image of the vehicle to determine if there are any differences. Thereafter, conditional branch point 250 tests to determine if any differences were detected when doing the comparison in step 240. If the test result in step 250 is YES, indicating that the captured image and the reference image match, and therefore the vehicle is considered unaltered, and hence safe to pass through the checkpoint, control passes to step 260, in which a signal indicating that the vehicle is safe to pass through the checkpoint is generated. The process is then exited in step 290. If the test result in step 250 is NO, indicating that the captured image and the reference image do not match, the vehicle is identified as likely to have been altered, and hence not safe to pass, but instead to be a candidate for further inspection. Therefore, control passes to step 270, in which a signal indicating that the vehicle is not safe to pass through the checkpoint is generated. Control is then passed to step 280.

In optional step 280, areas of difference between the captured image and the reference image may be pointed out, e.g., by drawing a circle around the area, placing pointers on the image showing the area of difference, highlighting the area of difference, or using other conventional display techniques. The reference image and the captured image may be displayed side by side on a monitor for the convenience of a human operator. Further, the operator may be able to manipulate the image, such as magnifying and/or rotating it to better see the change that was made to the vehicle.

The process is exited in step 290.

Note that the signal indicating that the vehicle is safe to pass and/or the signal indicating that the vehicle is not safe to pass may be human perceivable.

The foregoing merely illustrates the principles of the invention. It will thus be appreciated that those skilled in the art will be able to devise various arrangements, which, although not explicitly described or shown herein, embody the principles of the invention, and are included within its spirit and scope.

1. An apparatus comprising:
means for capturing an image of an area of a vehicle that should remain unaltered after a reference image for said area is stored;
means for comparing an image captured by said means for capturing to said reference image of said vehicle and for making a determination as to whether there exists at least one difference between said reference image and said captured image; and
means for producing an alert when it is determined that at least one difference exists.

2. The apparatus of claim 1 wherein said area that should remain unaltered is one of a group consisting of an underside of said vehicle and an engine compartment of said vehicle.

3. The apparatus of claim 1 wherein said means for comparing said image comprises a processor performing an image matching process.

4. The apparatus of claim 1 wherein said reference image is stored in a database.

5. The apparatus of claim 1 wherein said reference image is specified by an identifier of said vehicle.

6. The apparatus of claim 5 wherein said identifier is at least one of the group consisting of: i) a license plate number, ii) a vehicle identification number (VIN), iii) year, make and model information, iv) a radio tag identifier number, and v) a bar code.

7. The apparatus of claim 5 wherein said apparatus further comprises a radio tag receiver to obtain said identifier from a radio frequency identification (RFID) tag associated with said vehicle.

8. The apparatus of claim 5 wherein said apparatus further comprises a bar code reader to obtain said identifier from a bar code on a surface of said vehicle.

9. The apparatus of claim 5 wherein said apparatus obtains said identifier from character data on said vehicle.

10. The apparatus of claim 5 further comprising means for capturing said identifier.

11. The apparatus of claim 1 wherein said image capture system is operable to function under lighting conditions not suitable for use by human beings to perform inspections.

12. The apparatus of claim 1 further comprising means for displaying said at least one difference to a human being.

13. A method for inspecting an area of a vehicle, said method comprising the steps of:
capturing an image of said area of said vehicle that should remain unaltered after a reference image for said area is stored;
comparing said captured image to said reference image of said vehicle and making a determination as to whether there exists at least one difference between said reference image and said captured image; and
producing an alert when there exists at least one difference.

14. The method of claim 13 wherein said area of said vehicle is selected from the group consisting of an underside of said vehicle and an engine compartment of said vehicle.

15. The method of claim 13 wherein the step of comparing said captured image to a reference image further comprises the steps of:
obtaining an identifier of said vehicle; and
obtaining said reference image from a database as a function of said identifier.

16. The method of claim 15 wherein said identifier is selected from the group consisting of: i) a license plate number, ii) a vehicle identification number (VIN), iii) year, make and model information, iv) radio frequency identification (RFID) tag data, and v) bar code data.

17. A method of operating a system for inspecting an area of a vehicle, said system having a) an automated image capture system, b) at least one processor executing an image matching process, and c) said at least one processor having access to at least one database that stores a reference image, said method comprising the steps of:
capturing, with said automated image capture system, an image of said area of said vehicle that should remain unaltered after said reference image for said area is stored;
determining, by said processor, whether there exists any differences between said captured image and said reference image; and
producing an alert when the result of said determining step is that there exists at least one difference.

18. An apparatus operable to a) capture an image of an area of a vehicle that should remain unaltered after a reference image for said area is stored, b) compare said captured image to said reference image, and c) produce an alert when at least one difference exists between said captured image of said area and said reference image.

19. The apparatus of claim 18 wherein said apparatus identifies in a human perceivable manner at least one area of difference when there exists at least one difference.

20. An apparatus comprising:
a digital image capture for capturing a digital image of an area of a vehicle that should remain unaltered after a reference image for said area is stored;
an identification reader for obtaining an identifier of said vehicle; and
a processor for comparing said captured image of said area with a reference image obtained from a database of reference images of vehicles as a function of said identifier, and for generating an alert signal when at least one difference is found.

21. The apparatus of claim 20 wherein said processor is operable to execute an image matching process to compare said captured image to said reference image, and to make a determination as to whether there exists at least one difference between said reference image and said captured image.

22. The apparatus of claim 20 wherein said area of said vehicle is one of a group consisting of an underside of said vehicle and an engine compartment of said vehicle.
